(19) United States
(12) Patent Application Publication
(10) Pub. No.: US 2007/0154635 A1
(43) Pub. Date: Jul. 5, 2007

(54) Method of producing pigment injected oil paintings and article produced thereby

(76) Inventor: Regal Harrison Leftwich II, Springfield, VA (US)

Correspondence Address: Regal Harrison Leftwich II, 7705 Heming Place, Springfield, VA, 22151, US

(21) Appl. No.: 11/649,104

(22) Filed: Jan. 3, 2007

Related U.S. Application Data
(60) Provisional application No. 60/755,833, filed on Jan. 3, 2006.

(51) Int. Cl. B05D 5/00; B05D 1/28

(52) U.S. Cl. 427/180; 427/429; 427/256; 428/195.1

(57) ABSTRACT

A method is disclosed for producing a decorative and artistic effect on a flat surface, preferably a flat surface with some texture and primed with an acrylic based gesso, by brushing a un-pigmented drying oil, preferably boiled linseed oil, and applying a coating layer of pigment particles, having one or more colors, to the surface of the substrate and below the surface of the oil film. The process allows for a coating that allows for a minimal amount of pigment and oil and a surface thickness less than 0.010 of an inch. Once the coating is allowed to cure, the resultant article has the appearance of an oil painting with only a fraction of the pigment suspended in oil. Articles produced by this method are also encompassed within the invention.

This application claims the benefit of U.S. Provisional Application No. 60/755,833, filed Jan. 3, 2006.

### FIELD OF THE INVENTION

This invention relates to coating methods for producing a decorative and artistic effect on flat and textured surfaces. More particularly, this invention contemplates application of pigment, by commonly practiced techniques to one skilled in the art of crayons, pastels, and oil pastels, allowing the pigment applicators to contact the surface by passing through a film of oil which prevents the release of airborne dust particles and forms a protective coating when cured. The resultant effect of the present process provides an article of aesthetic function.

### BACKGROUND OF THE INVENTION

The ability to attach particles of colored pigment to the surface of the work is the underlying technical feat demonstrated by artists in the execution of drawings and paintings. The two most commonly used carriers of pigment are solid state mediums (such as crayons, pastels, and oil pastels) and liquid state mediums (such as oil paints). In the case of the solid state mediums the pigment particles are bound together and adhere to the surface of the work by friction. The liquid state mediums are comprised of pigment particles suspended in an oil which binds the pigment to the surface of the work.

Both mediums generate excessive pigment waste. Oil paint requires a very large amount of pigment to saturate the oil into a specific color. Whereas the use of solid mediums such as crayons, pastels, and oil pastels release a residual amount of dust particles into the atmosphere. The residual dust can expose the artist and others to toxic heavy metals such as cadmium, lead carbonate, cobalt and cobalt arsenate.

The solid state medium of crayons, pastels, and oil pastels lack a binding agent to permanently affix the pigment particles to the surface of the work once they are applied. Any attempt to protect the surface with traditional finishes or varnishes will alter the placement of the pigment particles. Many artists use spray fixatives because its application does not alter the final image, however, such fixatives also expose the user to toxic airborne chemicals.

Oil paints reside on the other end of the spectrum consisting of too much binding material. The binders commonly used in oil paints are extremely slow drying. It is common practice to mix paint thinners and drying oils with oil paints to vary the color and reduce the drying time. The addition of drying oils and thinners are generally applied to each color of an oil painting resulting in various layers with differing drying properties. Each layer must be allowed to dry before the application of additional layers and the layers must be applied in a specific order corresponding to their fat content or cracking can occur.

It is therefore a object of the present patent to provide a method for application of pigment to the surface of the work which minimizes the exposure to toxic substances and requires the minimum amount of oil to bind and protect the pigment and the surface of the work while consuming the minimum amount of pigment necessary to cover the surface of the work. Articles produced from the present invention will not crack and can be painted in a single sitting and greatly reduce the drying time.

### BRIEF SUMMARY

According to the present invention there is provided a coating method which combines a base coat of boiled drying oil in which the techniques utilized by one trained in the art of crayon, pastel, and oil pastel painting and drawing are applied to the surface before the oil dries.

The coating method according to the present invention eliminates the release of pigment particles into the atmosphere. The released pigment particles are trapped and suspended in the initial coat of drying oil which, when cured, bonds and protects the pigment particles attached to the substrate surface.

In oil paints, the pigment particles are suspended in such large quantities that the surface below the paint is covered by many layers of suspended particles. The coating produced is distinct from oil paint where a majority of the pigment is suspended in a carrier oil. In the present method, the coating is comprised of a layer of pigment below the layer of a drying oil with only the residual pigment dust suspended in the oil film. In the present method, only a small amount of pigment particles suspended in the oil layer with the majority of pigment particles used are attached to the surface of the work in a thin layer beneath the layer of oil.

The present method is distinct from prior art methods in which finishes are applied after an initial layer of pigment is completed. The layer of oil in the present invention not only protects the pigment layer when cured, it also aids in the application of the pigment. Due to the presence of the oil layer during pigment application, a secondary step of applying a finish after the application is not necessary.

Therefore, an objective of the present invention is to create a coating that combines a minimal amount of pigment with a minimal amount of oil and the method of creating this coating eliminates the dust generated from solid state media such as crayons, pastels, and oil pastels as well as any articles created through this method.

### BRIEF DESCRIPTION OF THE DRAWINGS

A greater understanding of the nature and materials of the present invention will become apparent upon consideration of the following detailed description, in connection with the accompanying drawings, wherein:

FIG. 1 is an exploded view of the materials necessary to demonstrate the technique and their spatial relationships.

FIG. 2 is a cross section view though a segment of the substrate and oil layer before the application of pigment.

FIG. 3 is a cross section view though a segment of the substrate and oil layer with pigment particles suspended in the oil and attached to the surface of the substrate.

### DETAILED DESCRIPTION

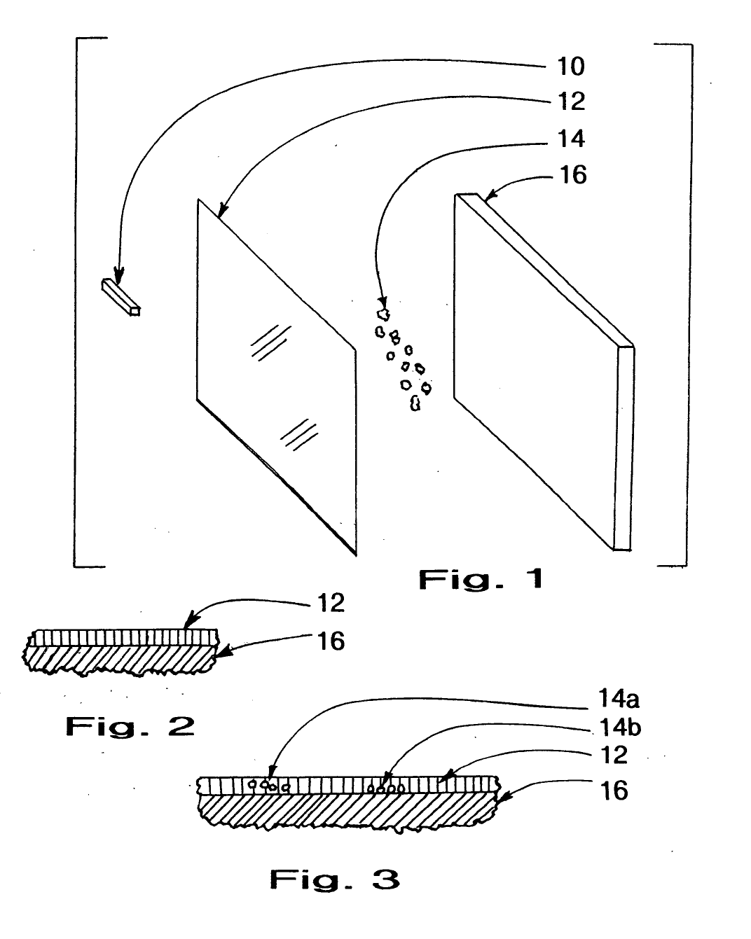

Referring now to the drawings, in FIG. 1 there is shown an exploded view of the relationship of the various components of the present invention. The pigment applicator 10 passes through the oil layer 12 and contacts the surface of the work 16 to deposit pigment particles 14.

The present method is intended to be applied to a rigid planar surface 16. Although not required to practice the present method, a pretreated surface is recommended.

FIG. 2 is a cross section that illustrates the initial step of the present method of coating the surface of the work 16 with a drying oil 12. A brush or squeegee is the best mode to apply the layer of oil to the surface of the work. Although only select parts of the surface may be coated, it is advised that the entire surface 16 be covered in a coat of oil 12.

The surface 16 may be unprimed, although a surface primed with a lead free acrylic based gesso is preferred. When cured, the coating produced using this technique will be less than 0.010 of an inch. Therefore, any texture desired must be created on the surface 16 as a step prior to the present process.

The drying oil 12 can be any of the most commonly used boiled drying oils such as: linseed oil, castor oil, pine nut oil, hempseed oil, poppy oil, walnut oil, bladderpod oil, sandmat oil, ironweed oil, calendula derived oil, hemp oil, poppyseed oil, sunflower oil, safflower oil, and soybean oil. Although any un-pigmented oil can be used with similar results, for the purposes of this method, I would restrict the present invention to non-toxic boiled drying oils with the siccative property of having an iodine number greater than 115, although not required I would suggest an iodine number of greater than 130 for optimal use. Linseed oil is the preferred drying oil due to its availability and relatively quick drying time, however, I would suggest poppy oil for practitioners who are opposed to the odoriferous properties of linseed oil.

The primary coating of un-pigmented oil 12 may seem confusing and counter intuitive for anyone trained in the art of oil painting, because fatter un-pigmented oil used as a primary coat will cause cracking in the paint. In the present invention the pigment 14 is layered below the layer of oil and should not be confused to the prior art involving the addition of multiple layers of pigment particles suspended in oils having varying iodine numbers or any process of adding pigment to the surface of an oil ground.

The second part of the present method involves applying pigment 14 to the surface of the work 16 through the layer of oil 12 by means commonly practiced by one skilled in the art of crayon, pastel, and/or oil pastel painting. Such means involve, but are not limited to, scraping and rubbing the surface with crayon, pastel, and oil pastel sticks, shown as 10 in FIG. 1, which deform as the pigment particles adhere to the surface of the substrate 16 shown in FIG. 3 as a pigment particle layer 14b. Also shown in FIG. 3 as 14a are the pigment dust particles suspended in the layer of oil 12. One familiar in the use of crayon, pastel, and oil pastel painting will find working with a oil covered surface unfamiliar. The techniques of applying color and blending pigment are well known to those skilled in the field of crayon, pastel, and oil pastel painting, however, due to the presence of oil a few additional techniques outside the normal scope of the art should be noted.

Influenced by gravity, the oil layer should settle into a uniform thickness after application. The time of this process depends on the type and brand of oil used. As the oil settles, it will not affect the pigment particles that adhere to the surface, but it can disturb the placement of any pigment dust particles that are suspended in the oil. If desired, this effect of particles pulled by gravity can be used for blending purposes. If this effect is not desired the artist can apply the crayon, pastel, or oil pastel in skimming strokes starting at one side of the work and moving toward the opposite side. To force excess oil and/or suspended pigment dust particles off of the surface, the preferred motion of the pigment applicator is downward. One skilled in the art will be able to reposition excess oil using the pigment applicator normally or by skimming motions slightly above the surface of the work 16 with the applicator 10 still immersed in the oil layer 12.

In the preferred execution of the present method, the pigment applicators of varied properties should be used. Other than the previously mentioned skimming motion, one skilled in the use of crayons, pastels, and oil pastels should find the commonly practiced techniques of applying, blending and mixing similar when executed under a layer of oil. It is suggested to keep a cloth or rag to remove any oil from the crayon, pastel, or oil pastel to avoid having to remove a hardened layer later. Oil that dries on the pigment applicator can be removed by scraping with the edge of a knife.

The surface of the work to be coated can be positioned vertically or horizontally or any position between when practicing the present method. There is no preferable position when applying the pigment particles. However, the finished coat should be allowed to cure in the vertical position to ensure a uniform thickness.

Although the preferred embodiment of the present invention has been described, it will be apparent to those skilled in the art that various changes and modifications may be made therein without departing from the spirit of the invention or the scope of the appended claims.

1. A process for producing a decorative coating less than 0.010 of an inch comprising the following steps:
(a) coating the surface of a rigid planer substrate, with a layer of un-pigmented boiled drying oil, such as linseed oil or poppy oil, having a iodine number greater than 115, through the use of a brush, squeegee or similar handheld application device;
(b) using the means commonly practiced by one skilled in the art of crayon, pastel, and oil pastel painting, such means as, but not limited to, scraping, rubbing, and blending the surface with crayon, pastel, oil pastel sticks, brush, and/or by hand or other hand held device, for the purpose of applying pigment particles to the surface of the work by passing through the layer of oil;
(c) skimming motions of the pigment applicator for the purpose of manipulating the oil coating and deposited pigment particles; and
(d) allowing the coating composition to cure.

2. A product in which an aesthetic image is produced by a process comprising the steps of claim 1.
